(19) United States
(12) Patent Application Publication
(10) Pub. No.: US 2007/0294859 A1
(43) Pub. Date: Dec. 27, 2007

(54) HINGE ASSEMBLY AND FOLDABLE ELECTRONIC DEVICE WITH SAME

(75) Inventors: SHENG-CHENG HSU, Tu-Cheng (TW); WEN-LIN GAN, Shenzhen (CN); LIAN-CHENG HUANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/567,579

(22) Filed: Dec. 6, 2006

(30) Foreign Application Priority Data
Jun. 23, 2006 (CN) 200610061298.2

(51) Int. Cl. E05D 11/10

(52) U.S. Cl. 16/330

(57) ABSTRACT

An exemplary hinge assembly (100) includes a shaft (10), a follower (20), a cam (30), a sleeve, a first elastic element (60), and a second elastic element (65). The follower having a projection (23) is rotatable in unison with the shaft. The cam has a cam surface (31). The cam is located around the shaft, with the cam surface abutting against the projection. The sleeve is located around the shaft, and is non-rotatable relative to the cam. The first elastic element has a first arm (61) and an opposite second arm (63). The first elastic element is located around the shaft, with the first arm being fixed relative to the sleeve, and the second arm being fixed relative to the shaft. The second elastic element is located around the shaft and abuts against the cam to bias the cam toward the follower.

### BACKGROUND OF THE INVENTION

1. Field of the Invention

The present invention generally relates to hinge assemblies, and particularly to a hinge assembly typically used for a foldable electronic device. The present invention further relates to a foldable electronic device with the hinge assembly.

2. Discussion of the Related Art

With the continued development of wireless communication and information processing technology, portable electronic devices such as mobile telephones and electronic notebooks are now in widespread use. These electronic devices enable consumers to enjoy the convenience of high technology services, anytime and almost anywhere. Foldable electronic devices are particularly favored by consumers for their convenience and ease-of-storage.

Generally, a foldable electronic device has most of the electronics in one housing, called the body. The other housing, the cover, normally contains fewer electronic components than the body. Other foldable electronic devices have all the electronic components in the body, with the cover containing no electronic component. Various types of hinge assemblies are used to join the body and the cover of a foldable electronic device, so that the cover can flip open from and flip close upon the body. Manufacturers are constantly seeking to reduce the volume, size, and/or weight of portable foldable electronic devices. Thus, it is desirable that the hinge assembly coupling the body with the cover is modularized and miniaturized. A modularized hinge assembly has moving parts such as a cam member, a cam follower, a shaft, and a spring held together in a unified structure. One of the cam member and the cam follower directly contacts the spring. The cam member and the cam follower are always in contact each other due to the force of the spring. However, a user must open the foldable electronic device using both hands. This makes the foldable electronic device awkward to utilize in situations when the user has only one hand free.

Therefore, a new hinge assembly is desired in order to overcome the above-described shortcomings.

### SUMMARY

A hinge assembly includes a shaft, a follower portion, a cam, a sleeve, a first elastic element, a second elastic element, and an endpiece. The shaft has a first end and a second end opposite to the first end. The follower portion has a projection. The follower portion is at the first end of the shaft and rotatable in unison with the shaft. The cam has a cam surface and a latching portion. The cam is located around the shaft, with the cam surface abutting against the projection of the follower portion. The sleeve defines a latching portion and a receiving groove. The sleeve is located around the shaft, with the latching portion of the sleeve engaging with the latching portion of the cam such that the sleeve is non-rotatable relative to the cam. The first elastic element has a first arm and a second arm opposite to the first arm. The first elastic element is located around the shaft, with the first arm being engaged in the receiving groove of the sleeve. The second elastic element has a first end and a second end opposite to the first end. The second elastic element is located around the shaft, with the first end abutting against the cam to bias the cam toward the follower portion. The endpiece having a receiving groove is fixed at the second end of the shaft, with the second end of the second elastic element biasing the endpiece, and the second arm of the first elastic element being engaged in the receiving groove of the endpiece.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present hinge assembly and foldable electronic device. Moreover, in the drawings, like reference numerals designate corresponding parts throughout the several views.

FIG. 1 is an isometric view of a mobile phone incorporating a hinge assembly (shown in phantom) in accordance with a preferred embodiment of the present invention.

FIG. 2 is an isometric view of the hinge assembly of the preferred embodiment.

FIG. 3 is an exploded view of the hinge assembly of FIG. 2.

FIG. 4 is similar to FIG. 3, but showing the hinge assembly viewed from another aspect.

FIG. 5 is a cross-sectional view taken along line V-V of FIG. 2.

### DETAILED DESCRIPTION OF THE EMBODIMENTS

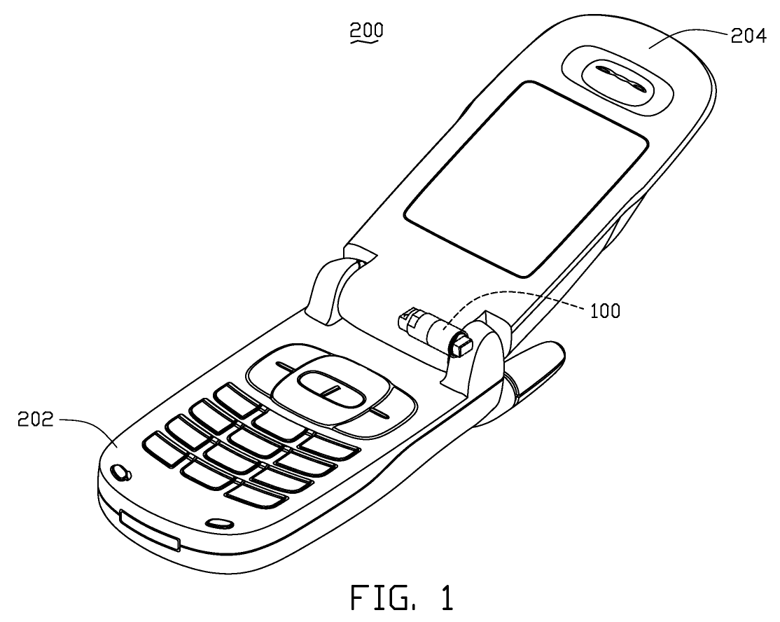

Referring to the drawings in detail, FIG. 1 shows a foldable electronic device 200 incorporating a hinge assembly 100 (shown in phantom) in accordance with a preferred embodiment. The foldable electronic device 200 is shown as a mobile phone 200. The mobile phone 200 is taken here as an exemplary application for the purposes of describing details of the hinge assembly 100. In alternative embodiments, the foldable electronic device 200 can instead be another kind of portable electronic device, such as a personal digital assistant (PDA). The mobile phone 200 includes a main body 202 and a cover 204. The main body 202 and the cover 204 are pivotably connected to each other via the hinge assembly 100.

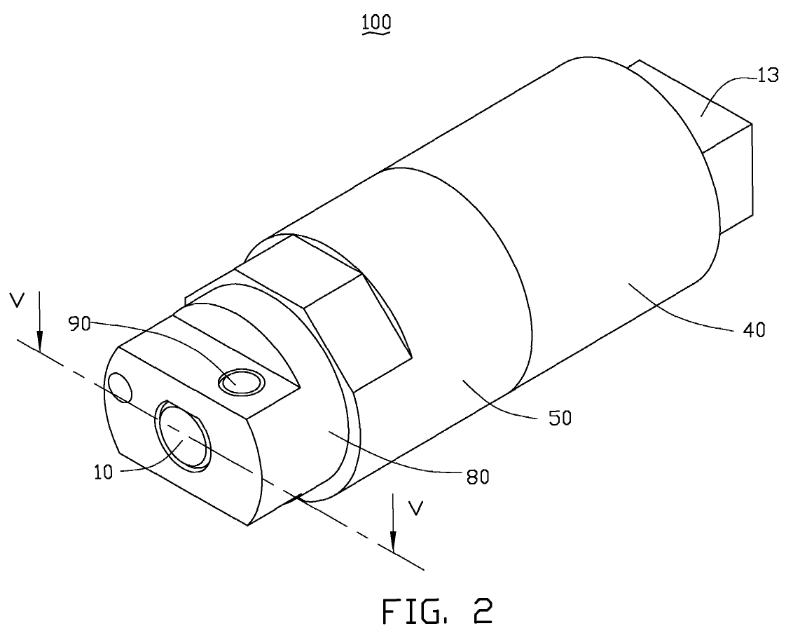

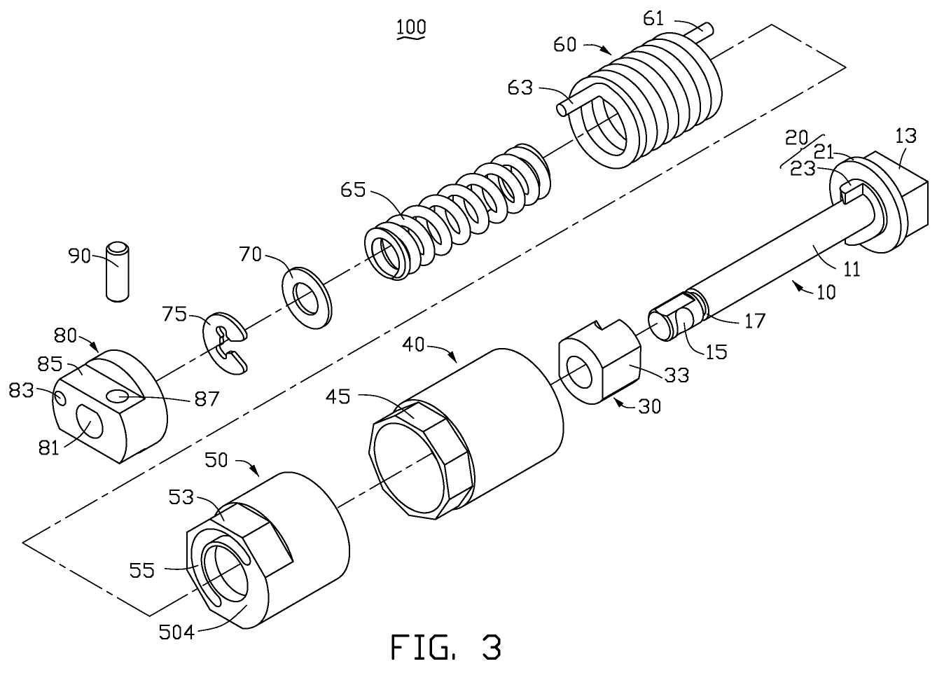

Referring to FIGS. 2 and 3, the hinge assembly 100 includes a shaft 10, a follower 20, a cam 30, a first sleeve 40, a second sleeve 50, a torsion spring 60, a compression spring 65, a washer 70, a clip 75, an endpiece 80, and a pin 90.

The shaft 10 includes a main portion 11, and a securing portion 13 extending from a first end of the main portion 11. The main portion 11 is substantially a cylindrical body, and defines a recess 15 at a second end thereof that is opposite to the first end. An annular clip groove 17 is defined in the main portion 11 adjacent to the recess 15. The securing portion 13 is configured for engaging with the main body 202 of the mobile phone 200. The securing portion 13 is substantially a rectangular body. In alternative embodiments, the securing portion 13 may be of another suitable shape, for example a polygonal body.

The follower 20 includes a flange 21, and a pair of projections 23 extending from the flange 21. The follower 20 is integrally formed with the main portion 11, and integrally adjoins the securing portion 13. In an alternative embodiment, the follower 20 can be formed as a separate piece, which is fixed around the main portion 11.

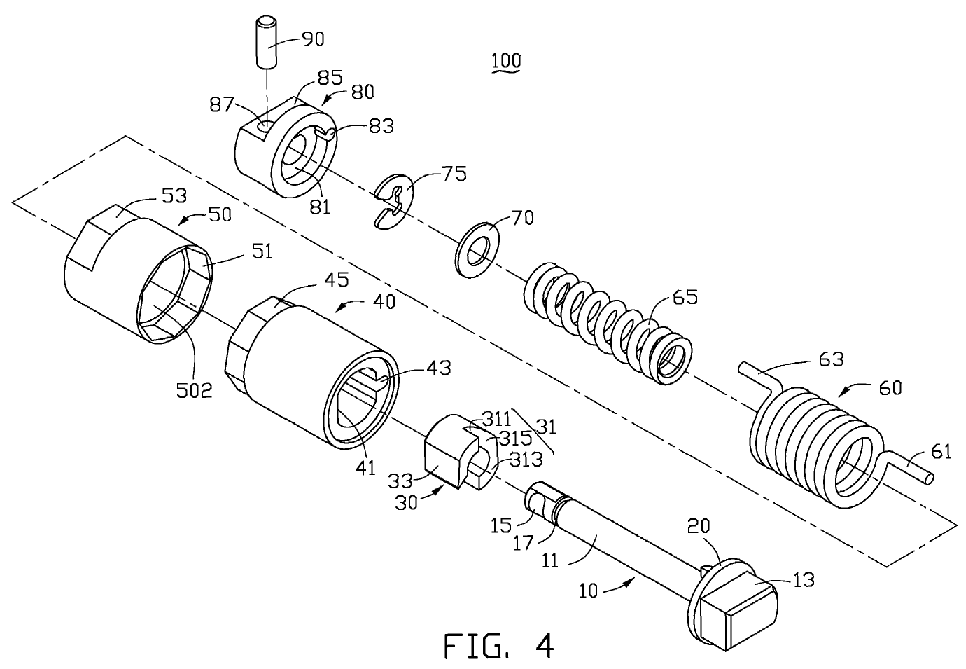

Referring also to FIG. 4, the cam 30 is substantially a hollow cylinder, and is placed around the main portion 11 of the shaft 10. The cam 30 has a cam surface 31 formed at a first end thereof. The cam surface 31 includes two valleys 311, two flat surfaces 313, and two inclined surfaces 315 each located between a corresponding one of the valleys 311 and a corresponding one of the flat surfaces 313. The cam surface 31 is configured for movably engaging with the projections 23 of the follower 20. A pair of latching portions 33 are formed at a periphery of the cam 30. In the illustrated embodiment, each latching portion 33 includes a substantial plane surface.

The first sleeve 40 is substantially a hollow cylinder. A pair of latching portions 41 are formed at an inside of a first end of the first sleeve 40. The latching portions 41 are configured for engaging with the latching portions 33 of the cam 30, whereby the first sleeve 40 is prevented from rotating relative to the cam 30. A shape and a size of the latching portions 41 correspond to those of the latching portions 33. In the illustrated embodiment, each latching portion 41 includes a substantial plane surface. In alternative embodiments, the latching portions 33 and 41 may be of other suitable shapes or configurations. For example, each latching portion 33 of the cam 30 may instead be a protrusion, and each latching portion 41 of the first sleeve 40 may instead be a recess engagingly receiving the corresponding protrusion. In other examples, there may be one, three or more latching portions 33 and one, three or more corresponding latching portions 41. A receiving groove 43 is defined in one of the latching portions 41. A locking portion 45 is formed at a periphery of a second end of the first sleeve 40. In the illustrated embodiment, an outer profile of the locking portion 45 is substantially polygonal.

The second sleeve 50 is substantially a hollow cylinder. The second sleeve 50 has an opening 502 at a first end thereof, and a partially-closed end 504 opposite to the opening 502. A locking portion 51 is formed at an inside of the second sleeve 50 at the opening 502. The locking portion 51 of the second sleeve 50 is configured for engaging with the locking portion 45 of the first sleeve 40, in order to fix the second sleeve 50 to the first sleeve 40. A shape of the locking portion 51 corresponds to that of the locking portion 45. In the illustrated embodiment, an inner profile of the locking portion 51 is substantially polygonal. In alternative embodiments, the locking portions 45 and 51 may be of other suitable shapes or configurations. For example, the locking portion 45 may instead be a generally rectangular protrusion, and the locking portion 51 may instead be a generally rectangular recess engagingly receiving the protrusion. A securing portion 53 is formed at a periphery of the second sleeve 50 at the partially-closed end 504. The securing portion 53 is configured for engaging with the cover 204 of the mobile phone 200. An outer profile of the securing portion 53 is substantially multi-sided. In alternative embodiments, the securing portion 53 may be of other suitable shapes or configurations. For example, the securing portion 53 may instead have a substantially polygonal outer profile, or may be in the form of a generally rectangular protrusion. The second sleeve 50 defines a slide groove 55 at the partially-closed end 504 thereof. The slide groove 55 is substantially arc-shaped, and a range of angles spanned by the slide groove 55 is in the range from about 160 to about 170 degrees.

The torsion spring 60 acts as a first elastic element, is helical, and is preferably metallic. The torsion spring 60 has a first arm 61, and a second arm 63 opposite to the first arm 61. The first arm 61 is received in the receiving groove 43 of the first sleeve 40, and the second arm 63 extends through the slide groove 55 of the second sleeve 50.

The compression spring 65 acts as a second elastic element, is helical, and is preferably metallic. The compression spring 65 is located around the main portion 11 of the shaft 10. A first end of the compression spring 65 abuts against a second end of the cam 30, and an opposite second end of the compression spring 65 abuts against the washer 70. In alternative embodiments, the compression spring 65 may be, for example, a tubular elastic piece.

The washer 70 has a first end surface (not labeled), and a second end surface (not labeled) opposite to the first end surface. The first end surface abuts against the second end of the compression spring 65 and the partially-closed end 504 of the second sleeve 50, and the second end surface abuts against the clip 75.

The clip 75 is substantially C-shaped. The clip 75 is engagingly received in the clip groove 17 of the shaft 10, and thereby abuts the washer 70.

The endpiece 80 is substantially a hollow cylinder, and has a stepped cavity 81 running through a middle thereof. The endpiece 80 defines a receiving groove 83. The receiving groove 83 is parallel to an axis of the endpiece 80, and runs through the endpiece 80 near a periphery of the endpiece 80. A distal end of the second arm 63 of the torsion spring 60 is received in the receiving groove 83. The endpiece 80 includes two symmetrically opposite plane steps 85 formed at a periphery thereof. The endpiece 80 further defines a pinhole 87. The pinhole 87 spans between the plane steps 85, and communicates with the cavity 81.

The pin 90 acts as a positioning member, and is cylindrical. A shape and a size of the pin 90 correspond to those of the pinhole 87 of the endpiece 80. The pin 90 is configured for locking the endpiece 80 with the shaft 10.

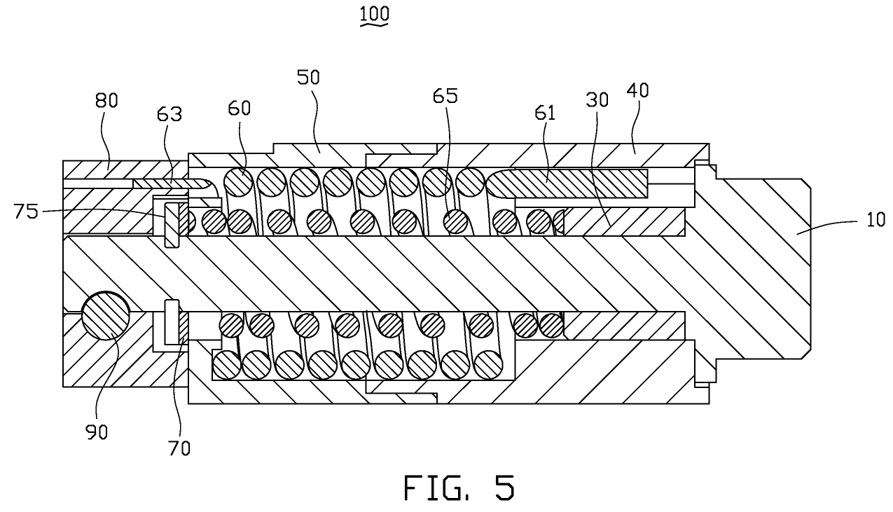

Referring also to FIG. 5, in assembly, the main portion 11 of the shaft 10 is passed through the cam 30, the torsion spring 60, the compression spring 65, the first sleeve 40, the second sleeve 50, and the washer 70 in that order. The clip 75 is engaged in the clip groove 17 of the shaft 10. The cam surface 31 of the cam 30 is thus engaged with the projections 23 of the follower 20. The latching portion 33 of the cam 30 is engaged with the latching portion 41 of the first sleeve 40, with the first end of the first sleeve 40 abutting against the flange 21 of the follower 20. The locking portion 45 of the first sleeve 40 is engaged with the locking portion 51 of the second sleeve 50 to integrate the first and second sleeves 40 and 50 into a whole unit. The first arm 61 of the torsion spring 60 is received in the receiving groove 43 of the first sleeve 40, and the second arm 63 extends through the slide groove 55 of the second sleeve 50. The compression spring 65 is somewhat compressed, with the first end thereof abutting against the second end of the cam 30, and the second end thereof abutting against the first end surface of the washer 70. The clip 75 abuts against the second end surface of the washer 70. The main portion 11 of the shaft 10 is passed through the stepped cavity 81 of the endpiece 80, with the second arm 63 of the torsion spring 60 being received in the receiving groove 83 of the endpiece 80. The endpiece 80 is rotated, and the pin 90 is received in a space cooperatively formed by the pinhole 87 of the endpiece 80 and the recess 15 of the shaft 10. Thus, the endpiece 80 is fixed with the shaft 10, with the torsion spring 60 twisted somewhat tight and having a pre-torsional force. Assembly of the hinge assembly 100 is thus completed.

In use, the securing portion 13 of the shaft 10 is engaged with the main body 202 of the foldable electronic device 200, and the securing portion 53 of the second sleeve 50 is engaged with the cover 204 of the mobile phone 200. When the mobile phone 200 is in a normal state, the cover 204 is closed and abuts the main body 202. In this position, the projections 23 of the follower 20 are engaged in the valleys 311 of the cam 30. The pre-torsional force of the torsion spring 60 is exerted on the first sleeve 40. Therefore the cam 30 is correspondingly biased, so that the cam 30 is under urging to rotate relative to the follower 20. However, a controlling member (not shown) of the mobile phone 200 prevents the cam 30 from rotating relative to the follower 20. The controlling member may for example be a magnetic mechanism. Thus, the cam 30 remains stationary relative to the follower 20.

To open the cover 204 of the mobile phone 200, the controlling member is manually released by a user. Thus the cam 30 rotates relative to the follower 20. According to such relative motion, each projection 23 of the follower 20 moves from the corresponding valley 311 toward the corresponding flat surface 313 via the corresponding inclined surface 315. In addition, the cam 30 moves toward the endpiece 80 and compresses the compression spring 65. Furthermore, the rotation of the cam 30 drives the first and second sleeves 40 and 50 to rotate relative to the shaft 10, with the first arm 61 of the torsion spring 60 rotating together with the first sleeve 40, and the second arm 63 of the torsion spring 60 sliding in the slide groove 55 of the second sleeve 50. Because the second sleeve 50 is engaged with the cover 204 of the mobile phone 200, there is no relative rotation between the second sleeve 50 and the cover 204. Therefore the second sleeve 50 drives the cover 204 to rotate relative to the main body 202, whereby the cover 204 is flipped open automatically.

To close the cover 204 is substantially the reverse of the above-described opening process. An external force is manually applied on the cover 204 by a user. Thus, the cover 204 drives the first and second sleeves 40 and 50 to rotate, and the first sleeve 40 drives the cam 30 to rotate. The torsion spring 60 is twisted and accumulates elastic potential energy, and the compression spring 65 decompresses and drives the cam 30 back toward the follower 20. Finally, the cover 204 is fully closed down onto the main body 202, and the mobile phone 200 is back in its normal state.

In alternative embodiments, the washer 70 and the clip 75 can be omitted. In such case, the second end of the compression spring 65 directly abuts against the endpiece 80. The pin 90 can be omitted. In such case, the endpiece 80 can be directly affixed around the second end of the shaft 10. The first sleeve 40 can be integrally formed with the second sleeve 50.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly comprising:
a shaft having a first end and a second end opposite to the first end;
a follower portion having a projection, the follower portion being at the first end of the shaft and rotatable in unison with the shaft;
a cam having a cam surface and a latching portion, the cam being located around the shaft, with the cam surface abutting against the projection of the follower portion;
a sleeve defining a receiving groove and a latching portion, the sleeve being located around the shaft, with the latching portion of the sleeve engaging with the latching portion of the cam such that the sleeve is non-rotatable relative to the cam;
a first elastic element for providing torsional force, the first elastic element having a first arm and a second arm opposite to the first arm, the first elastic element being located around the shaft, with the first arm being engaged in the receiving groove of the sleeve;
a second elastic element having a first end and a second end opposite to the first end, the second elastic element being located around the shaft, with the first end abutting against the cam to bias the cam toward the follower portion; and
an endpiece having a receiving groove, the endpiece being fixed at the second end of the shaft, with the second end of the second elastic element biasing the endpiece, and the second arm of the first elastic element being engaged in the receiving groove of the end piece.

2. The hinge assembly as claimed in claim 1, further comprising a washer, wherein the washer comprises a first end surface and a second end surface opposite to the first end surface, the second elastic element is a compression spring, and the washer is located between the compression spring and the endpiece, with the first end surface abutting against the second end of the compression spring.

3. The hinge assembly as claimed in claim 2, further comprising a clip, wherein the shaft defines a clip groove at the second end thereof, and the clip is engaged in the clip groove and abuts against the second end surface of the washer.

4. The hinge assembly as claimed in claim 1, wherein the cam surface is formed at an end of the cam, the cam surface comprises two valleys, two flat surfaces, and two inclined surfaces, and each of the inclined surfaces is located between a corresponding one of the valleys and a corresponding one of the flat surfaces.

5. The hinge assembly as claimed in claim 1, wherein the sleeve comprises a first sleeve member and a second sleeve member, each of the first and second sleeve members is substantially a hollow cylinder, the first sleeve member comprises a locking portion formed at a periphery thereof, the second sleeve member comprises a locking portion formed at an inside thereof, and the locking portion of the second sleeve member is engaged with the locking portion of the first sleeve member such that the second sleeve member is fixed with the first sleeve member.

6. The hinge assembly as claimed in claim 5, wherein a size of the locking portion of the second sleeve member corresponds to that of the locking portion of the first sleeve member, and a profile of the locking portion of the first sleeve member is polygonal, which corresponds to a polygonal profile of the locking portion of the second sleeve member.

7. The hinge assembly as claimed in claim 5, wherein the latching portion of the sleeve is formed at an inside of the first sleeve member, the latching portion of the cam is formed at a periphery thereof, and a shape of the latching portion of the sleeve corresponds to that of the latching portion of the cam, with each of the shapes comprising at least one flat surface.

8. The hinge assembly as claimed in claim 7, wherein the receiving groove of the sleeve is defined at the latching portion of the first sleeve member.

9. The hinge assembly as claimed in claim 5, wherein the second sleeve member has an opening at one end thereof and a partially-closed end opposite to the opening, the second sleeve member defines a slide groove formed at the partially-closed end, the first elastic element is a torsion spring, and the second arm of the torsion spring extends through the slide groove.

10. The hinge assembly as claimed in claim 8, wherein the receiving groove of the endpiece is parallel to an axis of the endpiece and runs through the endpiece.

11. The hinge assembly as claimed in claim 1, further comprising a positioning member, wherein the shaft defines a recess at the second end thereof, the endpiece defines a pinhole, and the positioning member is fixed in a space cooperatively formed by the pinhole of the endpiece and the recess of the shaft.

12. The hinge assembly as claimed in claim 11, wherein the positioning member is a cylindrical pin, which locks the endpiece with the shaft.

13. The hinge assembly as claimed in claim 1, wherein the endpiece is generally a hollow cylinder defining a cavity, the endpiece comprises two symmetrically opposite plane steps formed at a periphery thereof, and the pinhole spans between the two plane steps and communicates with the cavity.

14. A foldable electronic device, comprising:
a main body;
a cover; and
a hinge assembly pivotably connecting the main body and the cover, the hinge assembly comprising:
a shaft having a first end and a second end opposite to the first end, the shaft including a securing portion formed at the first end thereof, the securing portion being engaged with the main body;
a follower portion having a projection, the follower portion being at the first end of the shaft and rotatable in unison with the shaft;
a cam having a cam surface, the cam including a latching portion at a periphery thereof, the cam being located around the shaft, with the cam surface abutting against the projection of the follower portion;
a sleeve defining a receiving groove and a latching portion at an inside thereof, the sleeve including a securing portion at a periphery thereof, the sleeve being located around the shaft, with the latching portion of the sleeve engaging with the latching portion of the cam such that the sleeve is non-rotatable relative to the cam, the securing portion of the sleeve engaged with the cover;
a first elastic element having a first arm and a second arm opposite to the first arm, the first elastic element being located around the shaft, with the first arm being engaged in the receiving groove of the sleeve;
a second elastic element having a first end and a second end opposite to the first end, the second elastic element being located around the shaft, with the first end abutting against the cam to bias the cam toward the follower portion; and
an endpiece having a receiving groove, the endpiece being fixed at the second end of the shaft, with the second end of the second elastic element biasing the endpiece, and the second arm of the first elastic element being engaged in the receiving groove of the end piece.

15. The foldable electronic device as claimed in claim 14, wherein the hinge assembly further comprises a washer having a first end surface and a second end surface opposite to the first end surface, the second elastic element is a compression spring, and the washer is located between the compression spring and the endpiece, with the first end surface abutting against the second end of the compression spring.

16. The foldable electronic device as claimed in claim 15, wherein the hinge assembly further comprises a clip, the shaft defines a clip groove at the second end thereof, and the clip is engaged in the clip groove and abuts against the second end surface of the washer.

17. The foldable electronic device as claimed in claim 14, wherein the cam surface is formed at an end of the cam, the cam surface comprises two valleys, two flat surfaces, and two inclined surfaces, and each of the inclined surfaces is located between a corresponding one of the valleys and a corresponding one of the flat surfaces.

18. The foldable electronic device as claimed in claim 14, wherein the sleeve comprises a first sleeve member and a second sleeve member, each of the first and second sleeve members is substantially a hollow cylinder, the first sleeve member comprises a locking portion formed at a periphery thereof, the second sleeve member comprises a locking portion formed at an inside thereof, a cross-section of the locking portions of the first and second sleeve members are polygonal, and the locking portion of the second sleeve member is engaged with the locking portion of the first sleeve member such that the second sleeve member is fixed with the first sleeve member.

19. The foldable electronic device as claimed in claim 18, wherein the second sleeve member has an opening at one end thereof and a partially-closed end opposite to the opening, the second sleeve member defines a slide groove formed at the partially-closed end, the first elastic element is a torsion spring, and the second arm of the torsion spring extends through the slide groove.

20. A hinge mechanism, the hinge mechanism comprising:
a shaft;
a follower portion having a projection, the follower portion being at one end of the shaft and rotatable in unison with the shaft;
a cam having a cam surface and a latching portion, the cam being disposed around the shaft, with the cam surface abutting against the projection of the follower portion;
a sleeve having a latching portion, the sleeve being disposed around the shaft, with the latching portion of the sleeve engaged on the latching portion of the cam such that the cam is non-rotatable relative to the sleeve but slidable along an axis of the sleeve;
a first elastic element for providing torsional force, the first elastic element having a first arm and a second arm opposite to the first arm, the first arm being fixed relative to the sleeve, and the second arm being fixed relative to the shaft;
a second elastic element, the second elastic element being disposed around the shaft and abutting against the cam to bias the cam toward the follower portion; and
an endpiece having a receiving groove, the endpiece being fixed at an opposite end of the shaft, the second elastic element biasing the endpiece, and the second arm of the first elastic element being engaged in the receiving groove of the endpiece.
